(19) United States
(12) Patent Application Publication
(10) Pub. No.: US 2018/0339358 A1
(43) Pub. Date: Nov. 29, 2018

(54) FUME EXTRACTION ASSEMBLY FOR GAS SHIELDED WELDING

(71) Applicant: RoboVent Products Group, Inc., Sterling Heights, MI (US)

(72) Inventor: Michael Hattingh, Troy, MI (US)

(21) Appl. No.: 15/990,255

(22) Filed: May 25, 2018

Related U.S. Application Data
(60) Provisional application No. 62/511,919, filed on May 26, 2017.

(51) Int. Cl. B23K 9/32; B23K 9/16

(52) U.S. Cl. CPC B23K 9/325; B23K 9/164

(57) ABSTRACT

The present invention is a fume extraction system for use on a gas shielded welding device. The fume extraction system includes an extraction hose mounting bracket which has an internal flange adapted to mount about a welding torch. The bracket has a collar spaced from the internal flange that defines an interior space. A fume extraction port is in operative communication with the interior space. An intake shroud is mounted to the collar. The intake shroud is generally tubular and open at one end. The fume extraction port, interior space and shroud create an air-path through the extraction hose mounting bracket. In this way, the fume extraction system is connected to an air filter through the extraction port and the air filter draws air along said air-path through the interior space and the intake shroud without interfering with the gas shield welding operation.

### RELATED APPLICATIONS

This application claims the benefit of U.S. Provisional Application No. 62/511,919 filed on May 26, 2017, which is incorporated herein by reference.

### STATEMENT REGARDING FEDERALLY SPONSORED RESEARCH

NONE.

### TECHNICAL FIELD

This invention relates generally to an air filter system for use with gas shielded welding.

### BACKGROUND OF THE INVENTION

Welding operations create fumes due to the heat applied to and melting of the material welded. These fumes can be unpleasant at best and in some instances noxious. Typically, fumes in the welding area are filtered through an air filter system. Air filter systems have an intake in the welding area that pulls the air from the welding area and forces it through filters.

Although effective in most welding operations, typical air filter systems are not effective in many gas shielded wielding operations. The air filters pull the air at a velocity that can interfere with the gas shielding. What is needed is an air filter system that extracts the fumes from the welding operation, but doesn't interfere with the gas shielding.

Typical air filter systems include a large overhead hood to create a full enclosure, and can have complex and bulky ducting systems, and large floorspace duct collectors, whereas this system has a compact footprint, small hoses in the 1-3″ range typically and does not require overhead hood and enclosures or large complex ducting. This makes this system a lot more economical to implement, leaves a lot more room for manufacturing operations, and leaves unobstructed overhead access to the welding cell for example for overhead cranes access and material handling systems.

### SUMMARY OF THE INVENTION

In general terms, this invention provides a fume extraction system for use with a gas shielded welding device. The fume extraction system includes an extraction hose mounting bracket which has an internal flange adapted to mount about a welding torch. The bracket has a collar spaced from the internal flange that defines an interior space. A fume extraction port is in operative communication with the interior space. An intake shroud is mounted to the collar. The intake shroud is generally tubular and is open at one end. The fume extraction port, interior space and shroud create an air-path through the extraction hose mounting bracket. In this way, the fume extraction system can be connected to an air filter through the extraction port and the air filter draws air along said air-path through the interior space and the intake shroud without interfering with the gas shield welding operation.

These and other features and advantages of this invention will become more apparent to those skilled in the art from the detailed description of a preferred embodiment. Described below are the drawings that accompany the detailed description.

### BRIEF DESCRIPTION OF THE DRAWINGS

FIG. 1 is an exploded view of the fume extraction assembly for gas shielded welding unit of the present invention.

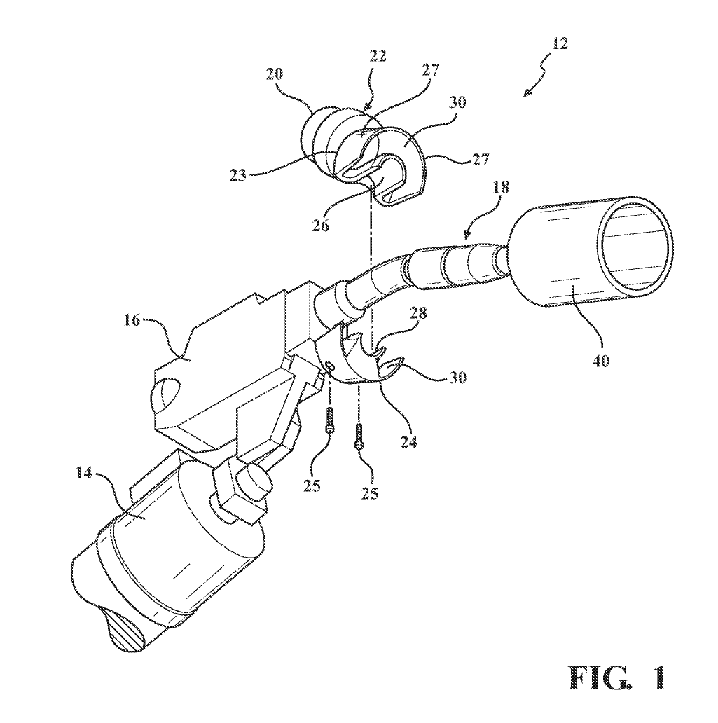

FIG. 2 is an exploded view of the fume extraction assembly for gas shielded welding unit of the present invention.

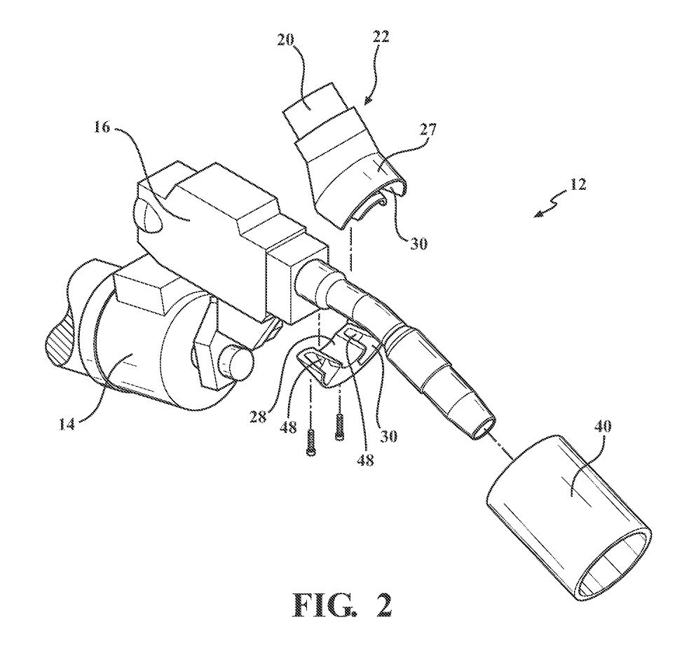

FIG. 3 is an exploded view of the fume extraction assembly for gas shielded welding unit of the present invention.

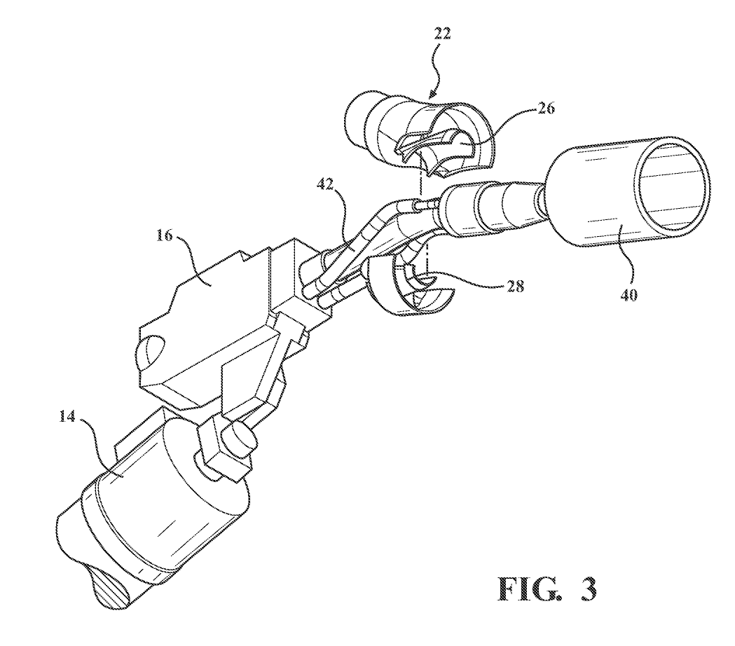

FIG. 4 is an exploded view of the fume extraction assembly for gas shielded welding unit of the present invention.

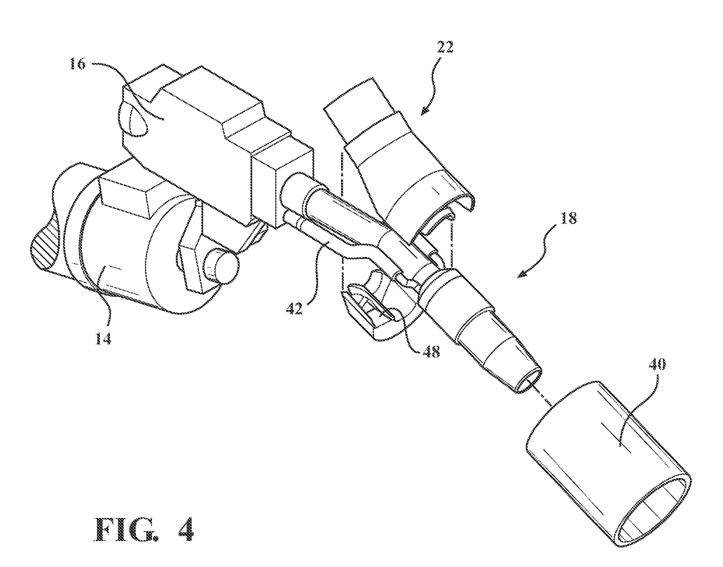

FIG. 5 is a perspective view of a gas shielded welding unit including the fume extraction assembly of the present invention.

FIG. 6 is a perspective view of the fume extraction assembly mounted to a welding nozzle.

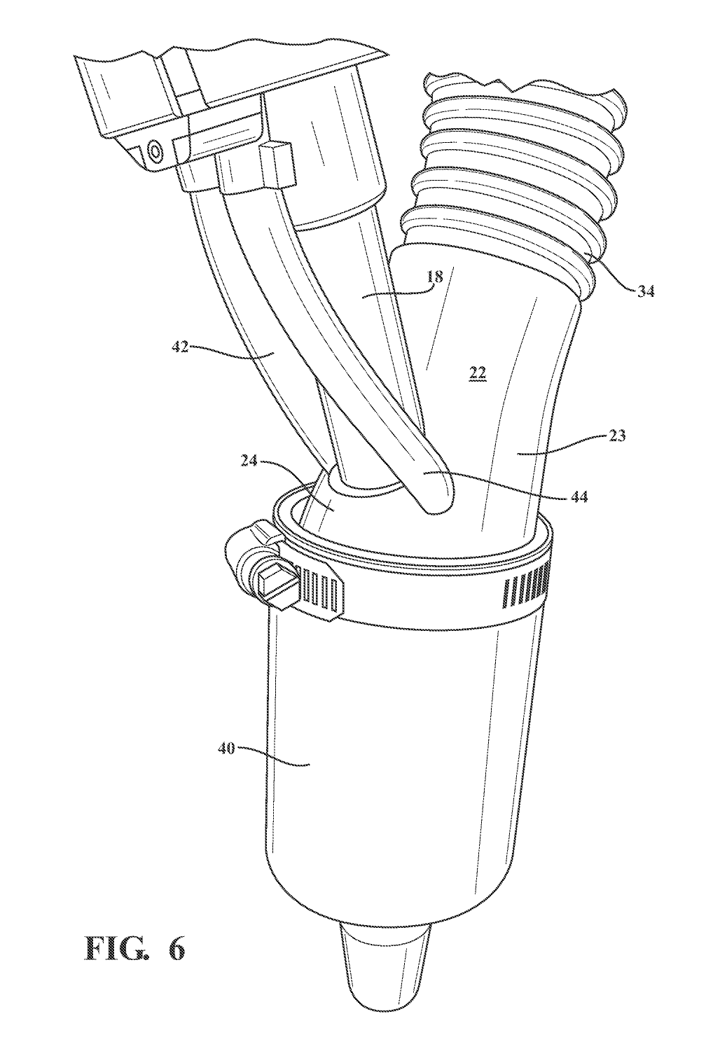

FIG. 7 is a side view of the fume extraction assembly of the present invention.

### DETAILED DESCRIPTION OF A PREFERRED EMBODIMENT

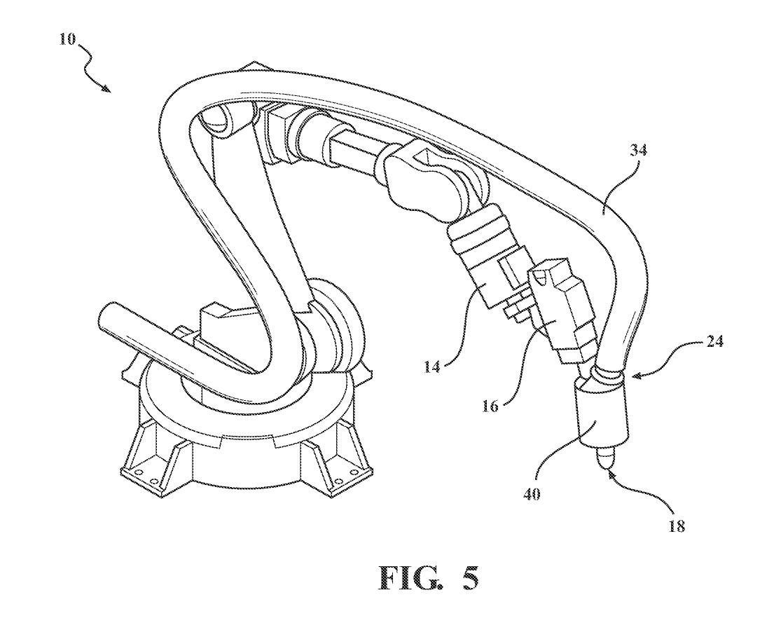

The fume extraction assembly of the present invention is shown generally at 12. The fume extraction assembly 12 is used in connection with gas shielded welding units shown generally at 10 in FIG. 5. The welding unit 10 as illustrated is a robotic welding unit. It will be appreciated by those of ordinary skill in the art, that the welding unit 10 can be any type of gas shielded welding unit, and the invention is not limited to robotic welding units.

The robotic welding unit as illustrated includes a torch mounting body 14 to which the welding torch gas nozzle 16 is attached. A welding torch 18 extends from the welding torch gas nozzle 16. The fume extraction system 12 is mounted to the welding torch 18.

The fume extraction system 12 of the present invention includes an extraction hose mounting bracket 22. The mounting bracket 22 of the present invention as disclosed has two separate parts, the first part 23 and second part 24. The two parts are connected together and in the disclosed embodiment, screws 25 are used to connect the two parts 23 and 24. It will be appreciated by those of ordinary skill in the art that other connection methods could be used, such as for example, adhesives, band clamps, welding, etc.

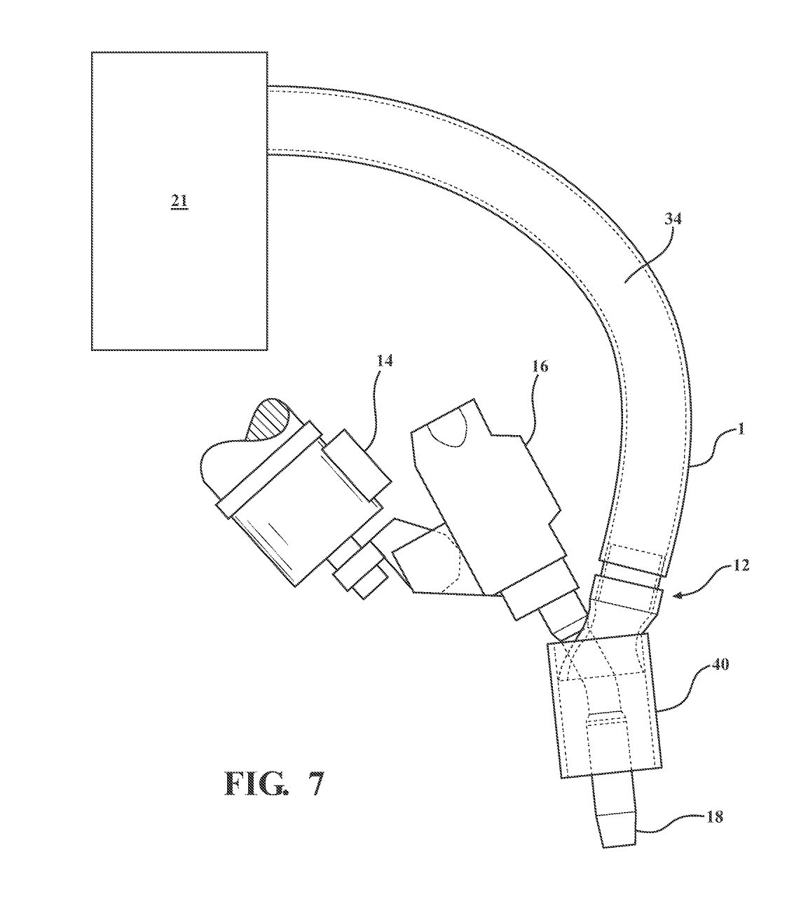

The first part 23 includes a fume extraction port 20 for receiving an extraction hose 34 which extends back to a filter unit 21 as illustrated in FIG. 7. The fume extraction port 20 and extraction hose 34 can be clamped with a band clamp, friction fit, threaded together, bayonet connected etc. The first and second parts 23 and 24 form a collar 27 when they are connected. The collar 27 receives a flexible intake shroud 40. In the disclosed embodiment, the shroud 40 is friction fitted onto collar 27. As with the fume extraction port 20, many different mounting methods could be used.

The first half 23 of the mounting bracket 22 includes an internal flange 26 which is configured to fit over the torch 18. An interior space 30 is located between the flange 26 and the wall of the collar 27. The interior space 30 is operatively connected to the extraction hose 34. The other half of the bracket 24 includes a mating flange 28 and a mating space 30. In the disclosed embodiment, the bracket 22 is made of PVC, but could for example be made of metal, reinforced plastic, plastic, etc.

In the disclosed embodiment, the flexible intake shroud 40 is flexible and flexes out of the way if there is any collision with the weldment workpiece, with the fixture etc. to prevent damage or adversely affect the calibration of the robot. The flexible intake shroud 40 is made from silicone material to withstand high heat from the weld arc since it is in close proximity of the welding operation. It is also positioned at a predetermined distance back from the weld tip (typically 1 to 3 inches depending on weldment type) to maximize fume capture before the thermal plume causes it to escape, while simultaneously far enough away to eliminate the possibility of sucking the shielding gas away from the weld which could cause weld porosity and poor weld structural integrity. Air is captured by the intake shroud at velocities typically between 2,500 ft/min and 6,800 ft/min.

The robotic welding unit 10 includes gas tubes 42 and 44 for the shield gas. In the disclosed embodiment, the bracket 22 includes mating grooves 48 to accept the gas tubes 42 and 44 within the bracket 22.

In use, the flexible hose 34 is attached to an air filter system 21. Air filter systems are well known in the art. Robovent is the assignee of the present application and engineers, manufactures, sells and installs air filter systems of the type used in the present invention. In very general terms, the air filter system 21 has a blower that draws air through the flexible hose 34 into the inlet to which the flexible hose 34 is attached. The air is drawn across filters that filter out particulates in the air and then returns to the air to the surrounding environment.

The hose 34 is connected to the robotic welder 10 through the bracket 22 and in particular to the fume extraction port 20. The air filter 21 draws air through the interior space 30 and the intake shroud 40 connected to the collar 27. The intake shroud 40 is positioned adjacent to the welding arc to suck in the resulting welding fumes created by the welding operation. The shroud 40 is positioned so that it doesn't interfere with the welding operation as shown in the figures.

The foregoing invention has been described in accordance with the relevant legal standards, thus the description is exemplary rather than limiting in nature. Variations and modifications to the disclosed embodiment may become apparent to those skilled in the art and do come within the scope of the invention. Accordingly, the scope of legal protection afforded this invention can only be determined by studying the following claims.

We claim:

1. A fume extraction system for use on a gas shielded welding device, said fume extraction system comprising:
an extraction hose mounting bracket, said extraction hose mounting bracket having an internal flange adapted to mount about a welding torch, a collar spaced from said internal flange defining an interior space, a fume extraction port in operative communication with said interior space;
an intake shroud having a proximal and distal end said proximal end is mounted to said collar, said intake shroud is generally tubular and open at said distal end;
said fume extraction port, interior space and shroud creating an air-path through said extraction hose mounting bracket;
whereby the fume extraction system is connected to an air filter through said extraction port, the air filter draws air along said air-path through said interior space and said intake shroud without interfering with the gas shield welding operation.

2. The fume extraction system of claim 1, wherein said mounting bracket has a first half and a second half, said first and second halves are connected together to join said internal flange about a welding torch.

3. The fume extraction system of claim 1, wherein said intake shroud is flexible.

4. The fume extraction system of claim 1, further including an extraction hose coupled to said extraction port.

5. The fume extraction system of claim 1, further including an air filter unit connected to said extraction port.

6. The fume extraction system of claim 5, further including an extraction hose interconnecting said air filter and said extraction port.

7. The fume extraction system of claim 1, wherein said extraction port is defined by an external mounting nipple.

8. The fume extraction system of claim 3, wherein said shroud is made of silicone.

9. A fume extraction system for use on a gas shielded welding device, said fume extraction system comprising:
an extraction hose mounting bracket, said extraction hose mounting bracket having an internal flange adapted to mount about a welding torch, a collar spaced from said internal flange defining an interior space, a fume extraction port in operative communication with said interior space;
an intake shroud having a proximal and distal end said proximal end is mounted to said collar, said intake shroud is generally tubular and open at said distal end;
said fume extraction port, interior space and shroud creating an air-path through said extraction hose mounting bracket;
an air filter system connected to said fume extraction port for extracting fumes from a welding operation;
whereby said air filter draws air along said air-path through said interior space and said intake shroud without interfering with the gas shield welding operation.

10. The fume extraction system of claim 1, wherein said mounting bracket has a first half and a second half, said first and second halves are connected together to join said internal flange about a welding torch.

11. The fume extraction system of claim 9, wherein said intake shroud is flexible.

12. The fume extraction system of claim 9, further including an extraction hose coupled between said extraction port and said air filter.

13. The fume extraction system of claim 10, wherein said extraction port is defined by an external mounting nipple.

14. A fume extraction system for use on a gas shielded welding device, said fume extraction system comprising:
a gas shielded welding device having a gas shielded welding torch with a neck portion ending in a welding tip;
an extraction hose mounting bracket, said extraction hose mounting bracket having an internal flange adapted to mount about said neck portion of said welding torch, a collar spaced from said internal flange defining an interior space, a fume extraction port in operative communication with said interior space;
an intake shroud having a proximal and distal end said proximal end is mounted to said collar, said intake shroud is generally tubular and open at said distal end, said distal end is mounted adjacent said welding tip;
said fume extraction port, interior space and shroud creating an air-path through said extraction hose mounting bracket;
an air filter system connected to said fume extraction port for extracting fumes from a welding operation;
whereby said air filter draws air along said air-path through said interior space and said intake shroud, without interfering with the gas shield welding operation.

15. The fume extraction system of claim 14, wherein said mounting bracket has a first half and a second half, said first and second halves are connected together to join said internal flange about a welding torch.

16. The fume extraction system of claim 14, wherein said intake shroud is flexible.

17. The fume extraction system of claim 14, further including an extraction hose coupled between said extraction port and said air filter.

18. The fume extraction system of claim 14, wherein said extraction port is defined by an external mounting nipple.
